(19) United States
(12) Patent Application Publication
(10) Pub. No.: US 2021/0003520 A1
(43) Pub. Date: Jan. 7, 2021

(54) X-Ray Fluorescence Analysis Apparatus and Calibration Method Thereof

(71) Applicant: JEOL Ltd., Tokyo (JP)

(72) Inventor: Genki Kinugasa, Tokyo (JP)

(21) Appl. No.: 16/918,243

(22) Filed: Jul. 1, 2020

(30) Foreign Application Priority Data
Jul. 4, 2019 (JP) 2019-125210

(51) Int. Cl. G01N 23/223

(52) U.S. Cl. CPC G01N 23/223; G01N 2223/076

(57) ABSTRACT

An opening is formed on a horizontal plate. A center of the opening coincides with a center of an X-ray passage area. A line-shaped member for calibration is provided passing the center of the opening. When an X-ray is irradiated onto a sample, an X-ray fluorescence from the sample and an X-ray fluorescence from the line-shaped member are detected at an X-ray detector. An X-ray spectrum produced by this detection includes a reference peak corresponding to the X-ray fluorescence from the line-shaped member, and energy calibration or the like is executed based on the reference peak.

### CROSS REFERENCE TO RELATED APPLICATION

This application claims priority to Japanese Patent Application No. 2019-125210 filed Jul. 4, 2019, the disclosure of which is hereby incorporated by reference in its entirety.

### BACKGROUND OF THE INVENTION

### Field of the Invention

The present disclosure relates to an X-ray fluorescence analysis apparatus and a calibration method thereof, and in particular to a technique of calibrating an X-ray fluorescence analysis apparatus using a calibration member.

### Description of Related Art

An X-ray fluorescence analysis apparatus is an apparatus in which an X-ray is irradiated onto a sample which is a measurement target, and the sample is analyzed by detecting an X-ray fluorescence emitted from the sample. Because the X-ray fluorescence has an energy characteristic to a substance, a substance contained in the sample can be identified by identifying an energy of the X-ray fluorescence.

In a calibration of the X-ray fluorescence analysis apparatus, a substance for calibration is used. The calibration substance is normally placed in place of the sample. When this configuration is employed, the calibration substance must be placed every time the calibration is executed, resulting in a problem in that the burden for a user becomes high and also a problem in that the calibration cannot be executed during sample measurement.

An X-ray fluorescence analysis apparatus disclosed in JP 10-48161 A includes a partitioning plate provided between a first space which houses a sample and a second space adjacent to the first space. An X-ray transmissive window is formed on the partitioning plate. On a shutter which opens and closes the X-ray transmissive window, a standard sample is provided as a calibration member. During the calibration, the shutter is set in a closed state, an X-ray is irradiated onto the standard sample, and an X-ray fluorescence from the standard sample is detected.

JP 2014-145617 A discloses in FIG. 4 an X-ray fluorescence analysis apparatus comprising a flow cell in which a liquid sample flows, and a correction element placed in an X-ray irradiation region in the flow cell. The correction element is a calibration member. The X-ray is irradiated simultaneously onto the liquid sample and the correction element. The correction element is provided at an end of the X-ray irradiation region. The correction element is formed as a metal evaporated film.

It is desired to enable execution of calibration of the X-ray fluorescence analysis apparatus at a necessary timing and in a simple manner. In the structure disclosed in JP 10-48161 A, it is necessary to set the shutter in the closed state during calibration, and the sample and the calibration substance cannot be measured simultaneously. In the structure disclosed in JP 2014-145617 A, a significant portion of the sample is covered by the calibration substance. Further, there is a possibility that a detection level of the X-ray fluorescence emitted from the calibration substance may significantly vary due to variations in a position or a size of an irradiation area of the X-ray.

An advantage of the present disclosure lies in enabling simple execution of calibration of the X-ray fluorescence analysis apparatus at a necessary timing. Alternatively, an advantage of the present disclosure lies in enabling stable detection of X-ray fluorescence from the calibration substance.

### SUMMARY OF THE INVENTION

According to one aspect of the present disclosure, there is provided an X-ray fluorescence analysis apparatus comprising: a partitioning member; an X-ray generator; an X-ray detector; a spectrum producer; and a line-shaped member for calibration, which is provided as a permanent element. The partitioning member is a member which separates a first space and a second space adjacent to the first space, and is, for example, a partitioning plate. In the first space, a sample is provided as a measurement target, and, in the second space, the X-ray generator and the X-ray detector are provided. An opening for allowing passage of an X-ray to be irradiated onto the sample is formed on the partitioning member. The line-shaped member for calibration is provided crossing the opening. When the X-ray is irradiated onto the sample, both an X-ray fluorescence from the sample and an X-ray fluorescence from the line-shaped member are detected. An X-ray fluorescence spectrum is produced based on a detection signal from the X-ray detector. The X-ray fluorescence spectrum includes a sample peak corresponding to the X-ray fluorescence from the sample and a reference peak corresponding to the X-ray fluorescence from the line-shaped member.

According to the structure described above, during the irradiation of the X-ray onto the sample, the X-ray fluorescence for calibration can be observed. Thus, it becomes unnecessary to place the calibration member in place of the sample every time the calibration is executed. With one instance of X-ray irradiation, the calibration and the sample analysis can be executed consecutively or simultaneously. Although the line-shaped member crosses the opening, by forming the line-shaped member as a narrow line member, a sufficient amount of irradiation of the X-ray onto the sample can be secured, and sensitivity reduction due to the line-shaped member can be practically ignored.

In an embodiment, the line-shaped member is a straight-line-shape member having a uniform diameter at every position in its axial direction. Such a line-shaped member can be easily manufactured. Alternatively, a commercially available product may be used as the line-shaped member for calibration. Alternative configurations may also be considered in which the cross section of the line-shaped member is quadrangular or polygonal. In an embodiment, the line-shaped member is placed in such a manner that a self-absorption or a self-blockage of the X-ray fluorescence by the line-shaped member itself is minimized; that is, a number of locations of generation of the X-ray fluorescence is minimized at a rear side in the line-shaped member, as viewed from the X-ray detection side. In addition, the line-shaped member is placed in such a manner that calibration can be executed with high precision even when a size of the X-ray irradiation region is varied.

According to another aspect of the present disclosure, the line-shaped member crosses a central part of an X-ray passage area in the opening. According to this structure, even when the position of the X-ray passage area changes slightly, or even when the size of the X-ray passage area changes, the line-shaped member can be stably measured. Normally, a center of the opening and a center of the X-ray passage area are coincided, and, in an embodiment, the line-shaped member is placed to cross the center of the opening. Even when the center of the X-ray passage area is slightly deviated from the center of the opening, the problem of the sensitivity reduction or the like does not occur so long as the line-shaped member passes the central part of the X-ray passage area. Here, the central part is a concept including regions near the center.

According to another aspect of the present disclosure, the X-ray generator irradiates the X-ray onto the sample from a first slanted direction, and the X-ray detector detects the X-ray fluorescence emitted from the sample in a second slanted direction and the X-ray fluorescence emitted from the line-shaped member in the second slanted direction. In this case, the line-shaped member is provided along a direction of arrangement of the X-ray generator and the X-ray detector. According to this configuration, the self-absorption or the self-blockage of the X-ray fluorescence by the line-shaped member itself can be reduced. The X-ray passage area normally has an elliptical shape with a long axis and a short axis. For example, the line-shaped member is provided along the long axis or the short axis of the X-ray passage area. When the line-shaped member is placed along the long axis of the X-ray passage area, even when a diameter or a cross sectional size thereof is reduced, the X-ray irradiation region on the line-shaped member can be increased.

According to another aspect of the present disclosure, the partitioning member has a first surface which faces the first space, and a second surface which faces the second space, and the line-shaped member is provided on the second surface. Because the first surface is a surface which is or which may be in contact with the sample, the line-shaped member is provided on the second surface, which is a surface opposite the first surface. In alternative configurations, the line-shaped member may be placed on the first surface, or may be placed in the opening.

According to another aspect of the present disclosure, respective ends of the line-shaped member are fixed on the second surface. For the fixation, a fixing tool, an adhesive, or the like may be used. Alternatively, the line-shaped member may be fixed in an exchangeable manner. Alternatively, a plurality of line-shaped members may be provided crossing the opening and along the partitioning member. In this case, the plurality of line-shaped members may be formed from a plurality of calibration substances which differ from each other. Alternatively, a single line-shaped member may be formed from a plurality of the calibration substances.

According to another aspect of the present disclosure, there is provided a calibration method, comprising: providing a line-shaped member for calibration crossing an opening formed on a partitioning member provided between a first space which houses a sample and a second space adjacent to the first space; irradiating an X-ray generated in the second space toward the opening; detecting an X-ray fluorescence from the line-shaped member in the second space; producing an X-ray fluorescence spectrum including a reference peak corresponding to the X-ray fluorescence from the line-shaped member; and executing at least one of energy calibration or intensity calibration based on at least one of an energy or an intensity of the reference peak. Alternatively, calibration (or error determination) and sample analysis may be simultaneously executed based on the same X-ray fluorescence spectrum.

### BRIEF DESCRIPTION OF THE DRAWINGS

Embodiment(s) of the present disclosure will be described based on the following figures, wherein:

FIG. 1 is a diagram showing a first configuration of an X-ray fluorescence analysis apparatus according to an embodiment of the present disclosure;

FIG. 2 is a diagram showing an example of a line-shaped member for calibration;

FIG. 3 is a diagram showing a first example of an X-ray fluorescence spectrum;

FIG. 4 is a flowchart showing an example operation of an X-ray fluorescence analysis apparatus;

FIG. 5 is a diagram showing a threshold setting screen;

FIG. 6 is a diagram showing a second configuration of an X-ray fluorescence analysis apparatus according to an embodiment of the present disclosure;

FIG. 7 is a diagram showing a line-shaped member array; and

FIG. 8 is a diagram showing a second example of an X-ray fluorescence spectrum.

### DESCRIPTION OF THE INVENTION

An embodiment of the present disclosure will now be described with reference to the drawings.

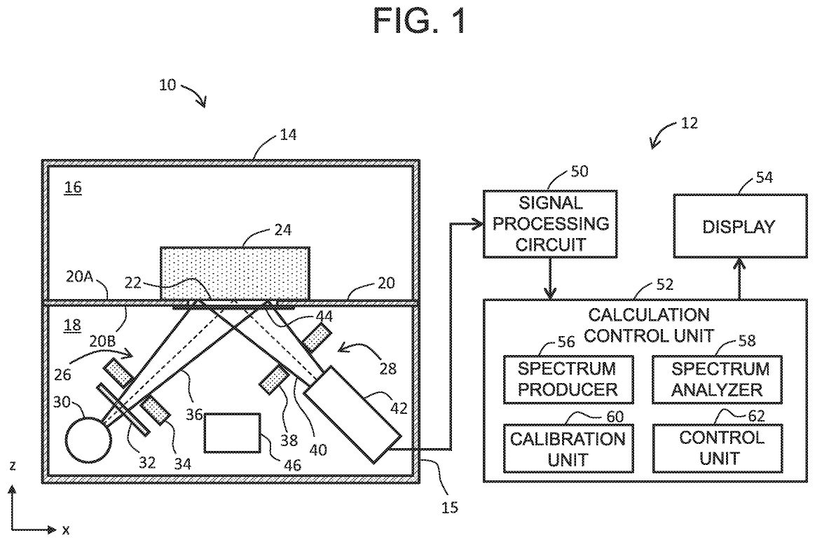

FIG. 1 shows a first configuration of an X-ray fluorescence analysis apparatus according to an embodiment of the present disclosure. The X-ray fluorescence analysis apparatus is used for analysis of a substance forming a sample; more specifically, qualitative analysis and quantitative analysis of the substance. The illustrated X-ray fluorescence analysis apparatus generally comprises a measurement unit 10 and an information processor 12.

The measurement unit 10 comprises an upper part 14 and a lower part 15. An inside of the upper part 14 is a sample chamber 16 serving as a first space. The sample chamber 16 is surrounded by an upper housing. Normally, the inside of the sample chamber 16 is set at atmospheric pressure, but alternatively, the inside of the sample chamber 16 may be set to a vacuum state. A sample 24 is placed in the sample chamber 16. The sample 24 is, for example, a solid sample, a powder sample, a liquid sample, or the like.

An inside of the lower part 15 is a measurement chamber 18 serving as a second space. An X-ray irradiation unit 26 and an X-ray detection unit 28 are provided in the measurement chamber 18. The measurement chamber 18 is surrounded by a lower housing. A horizontal plate 20 which functions as a sample stage is provided between the sample chamber 16 and the measurement chamber 18. The horizontal plate 20 may also be referred to as a partitioning plate which separates the two spaces. The horizontal plate 20 has an upper surface 20A which faces the sample chamber 16 and a lower surface 20B which faces the measurement chamber 18. An opening 22 is formed in the horizontal plate 20. Through the opening 22, the sample 24 is partially exposed to the side of the measurement chamber 18. The opening 22 has a circular shape. In FIG. 1, a first horizontal direction is an x direction, a second horizontal direction is a y direction, and a vertical direction is a z direction.

The X-ray irradiation unit 26 irradiates an X-ray through the opening 22 onto the sample 24 from a first slanted direction. The X-ray detection unit 28 detects an X-ray fluorescence emitted from the sample 24 through the opening 22 in a second slanted direction. The first slanted direction and the second slanted direction are shown by two broken lines in FIG. 1. The two broken lines correspond respectively to center lines of two X-ray beams 36 and 40 to be described below. The first slanted direction and the second slanted direction are in an xz plane.

The X-ray irradiation unit 26 comprises an X-ray generator 30, a primary filter 32, a collimator 34, and the like. On the collimator 34, a plurality of openings having different sizes are formed, and, with a movement of the collimator 34, an opening to be used is selected. With this configuration, a size of the X-ray beam 36 is selected. The selection of the opening is executed by a collimator driving mechanism (not shown).

The X-ray detection unit 28 has a collimator 38, an X-ray detector 42, and the like. Alternatively, a secondary filter may be provided as a part of the X-ray detection unit 28. An opening for allowing an X-ray fluorescence to pass is formed on the collimator 38, and a size of the X-ray beam 40 is defined by the opening. Cooling equipment is provided on the X-ray detector 42.

A camera 46 is an imaging device for observing the sample 24 through the opening 22. The X-ray generator 30 and the X-ray detector 42 are arranged in the x direction. An X-ray passage area in the opening 22 and an X-ray irradiation area on a lower surface of the sample 24 both have an elliptical shape. When the size of the X-ray beam 36 is changed stepwise, the sizes of the X-ray passage area and the X-ray irradiation area change stepwise. An angle of the first slanted direction with reference to the z axis is, for example, +45 degrees, and an angle of the second slanted direction is, for example, −45 degrees.

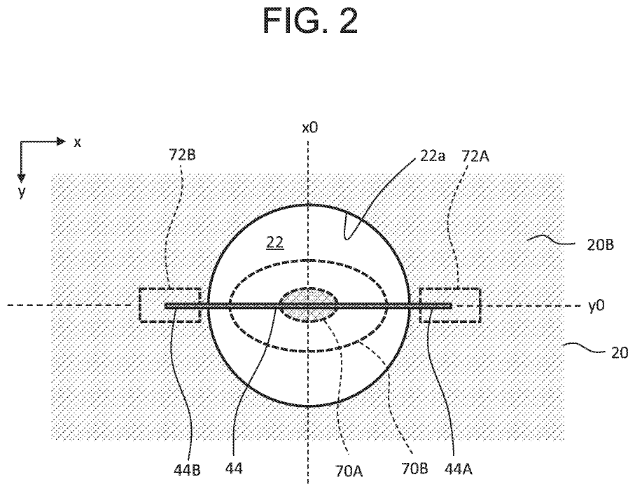

On the lower surface 20B of the horizontal plate 20, a line-shaped member 44 for calibration is provided. Specifically, the line-shaped member 44 is provided crossing the center of the opening 22 in a direction parallel to the x direction. The line-shaped member 44 is a narrow line member having a straight-line form. A cross section of the line-shaped member 44 is circular. The line-shaped member 44 will be described later in detail with reference to FIG. 2. When an X-ray is irradiated by the X-ray irradiation unit 26 toward the opening 22, a part of the X-ray reaches the line-shaped member 44, and a remaining part of the X-ray which forms a large part thereof reaches the sample 24. Both of the X-ray fluorescence emitted from the line-shaped member 44 and the X-ray fluorescence emitted from the sample 24 are simultaneously observed by the X-ray detector 42. Because the line-shaped member 44 extends along the x direction which is the direction of arrangement of the X-ray generator 30 and the X-ray detector 42, it is possible to reduce a self-absorption or a self-blockage of the X-ray fluorescence caused in the line-shaped member 44, as compared to a case in which the line-shaped member is placed orthogonal to the x direction; that is, parallel to the y direction. In other words, portions corresponding to the shadow can be reduced when viewed from the X-ray detector 42.

Next, the information processor 12 will be described. The information processor 12 comprises a signal processing circuit 50, a calculation control unit 52, a display 54, and the like. To the calculation control unit 52, an inputter is connected in addition to the display 54, but is not shown in the figures. The signal processing circuit 50 is a circuit which processes a detection signal which is output from the X-ray detector 42, and includes an amplifier, an A/D converter, and the like.

The calculation control unit 52 is formed from, for example, a computer having a CPU which executes a program. In FIG. 1, a plurality of functions of the calculation control unit 52 are shown by a plurality of blocks. More specifically, the calculation control unit 52 comprises a spectrum producer 56, a spectrum analyzer 58, a calibration unit 60, and a control unit 62.

The spectrum producer 56 produces an X-ray spectrum based on the detection signal. The X-ray spectrum includes a sample peak corresponding to the X-ray fluorescence emitted from the sample 24, and a reference peak corresponding to the X-ray fluorescence emitted from the line-shaped member 44. As will be described later, the reference peak may be set as a reference for energy calibration and intensity calibration. The energy calibration and the intensity calibration may be executed automatically manually. Alternatively, a validity of the X-ray spectrum may be judged based on a visual checking of the reference peak included in the X-ray spectrum. In the present embodiment, the reference peak is observed at all times during the sample measurement.

The spectrum analyzer 58 identifies a substance included in the sample 24 based on the sample peak included in the X-ray spectrum, and analyzes a concentration of the substance as necessary. In addition, the spectrum analyzer 58 also has a function to identify the reference peak included in the X-ray spectrum, and to analyze an energy and an intensity of the reference peak. The line-shaped member 44 is formed from a known substance, and the energy (energy standard value) of the reference peak and the intensity (intensity standard value) of the reference peak are identified in advance.

The calibration unit 60 executes energy calibration based on a deviation of an accrual energy of the reference peak from the energy standard value when it is judged that the energy calibration is necessary. In addition, the calibration unit 60 executes intensity calibration based on a deviation of an actual intensity of the reference peak from the intensity standard value when it is judged that the intensity calibration is necessary. Alternatively, a configuration may be employed in which only the former of the energy calibration and the intensity calibration is executed. Alternatively, such a calibration may be executed manually. The control unit 62 controls operations of the measurement unit 10. The display 54 is formed from a display device such as an LCD. The X-ray spectrum, an analysis result, a calibration result, and the like are displayed on the display 54.

FIG. 2 shows the horizontal plate 20, as viewed from below. FIG. 2 shows the line-shaped member 44. Ends 44A and 44B of the line-shaped member 44 are fixed on the lower surface 20B of the horizontal plate 20. The line-shaped member 44 is a narrow line member having a uniform diameter along its longitudinal direction, and the diameter is, for example, less than or equal to 100 μm, and is desirably 5 μm˜20 μm. The length of the line-shaped member 44 is set to be greater than or equal to a diameter of the opening 22. The line-shaped member 44 has a straight line form, parallel to the x direction.

The opening 22 has a circular shape, and the X-ray beam passes the inside thereof. Reference numeral 22a shows an edge of the opening 22. When a first opening size is selected as the opening size of the collimator, an X-ray passage area 70A is formed in the opening 22.

When a second opening size is selected as the opening size of the collimator, an X-ray passage area 70B is formed in the opening 22. These X-ray passage areas 70A and 70B both have an elliptical form. A center of the opening 22 and centers of the X-ray passage areas 70A and 70B are basically coincided. Coordinates of the center of the opening are shown by (x0, y0). The line-shaped member 44 extends through the center coordinates (x0, y0), and crosses the opening 22 in the x direction.

Even when the centers of the X-ray passage areas 70A and 70B are slightly deviated in the y direction from the center of the opening 22, the line-shaped member 44 still passes through central parts of the X-ray passage areas 70A and 70B. Here, the central part is a concept including regions near the center, and is, for example, a circular portion with an origin at the center. For example, when an area of the smallest X-ray passage area among the X-ray passage areas 70A and 70B is set as 100%, an area of the central part may be 10% or smaller than 10%.

If the line-shaped member 44 is provided crossing an end of the opening 22 in the y direction (an upper end or a lower end in FIG. 2), the intensity of the X-ray fluorescence from the line-shaped member 44 may easily vary when the X-ray passage areas 70A and 70B are deviated in the y direction or when the size of the X-ray beam is changed. On the contrary, in the present embodiment, because the line-shaped member 44 extends through the center of the opening 22, the X-ray fluorescence can be stably detected. Further, because the line-shaped member 44 is provided along the x direction which is the direction of arrangement of the X-ray generator and the X-ray detector, as described above, the problem of the self-absorption or the self-blockage by the line-shaped member 44 can be reduced.

The line-shaped member 44 is formed from a single material or from a plurality of materials. When the area of the opening 22 in the xy plane is set as 100%, an area of the portion of the line-shaped member 44 over the opening 22 is, for example, 3% or smaller, and is desirably 1% or smaller. So long as the reference peak can be clearly identified, a smaller area ratio may be employed. When an area of the smallest X-ray passage area in the xy plane is set as 100%, the area of the line-shaped member 44 is, for example, 10% or smaller, and is desirably 5% or smaller. Alternatively, a smaller area ratio may be employed. It should be noted that the numerical values described herein are merely exemplary.

Alternatively, the line-shaped member 44 may be provided at the side of the upper surface of the horizontal plate 20, but by providing the line-shaped member 44 on the lower surface 20B of the horizontal plate 20, an advantage can be obtained in that the line-shaped member 44 does not become an obstacle when the sample is placed and in that the available space can be effectively utilized. Fixation members 72A and 72B may each be an adhesive or a fixation fitting. Alternatively, the line-shaped member 44 may be fixed in an exchangeable manner.

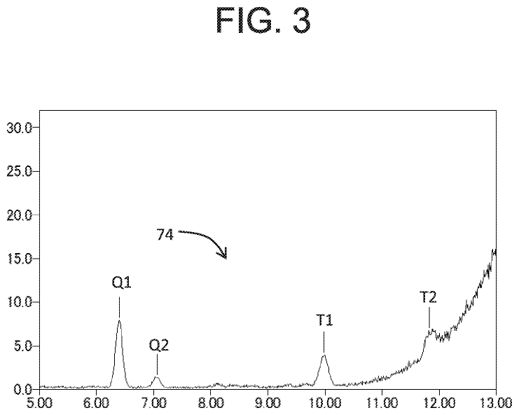

FIG. 3 shows a first example of an X-ray spectrum (X-ray fluorescence spectrum) observed by the X-ray fluorescence analysis apparatus of the present embodiment. In the illustrated example configuration, an X-ray spectrum 74 includes two sample peaks T1 and T2, and two reference peaks Q1 and Q2. The sample peaks T1 and T2 correspond to two X-ray fluorescences emitted from the sample. The reference peaks Q1 and Q2 correspond to two X-ray fluorescences emitted from the line-shaped member. The necessity of the energy calibration is judged based on, for example, the reference peak Q1 of the reference peaks Q1 and Q2, and the energy calibration is executed. In FIG. 3, a horizontal axis is an energy axis and a vertical axis is an intensity axis. Desirably, the line-shaped member is formed from a substance other than the substance forming the sample.

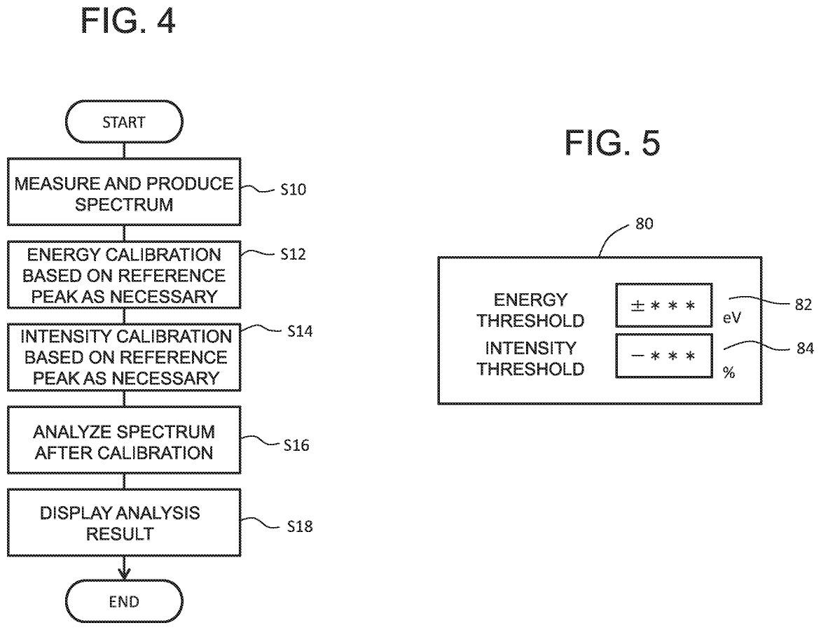

FIG. 4 shows an example operation of the X-ray fluorescence analysis apparatus according to the present embodiment. In S10, measurement of an X-ray fluorescence is executed, and an X-ray spectrum is consequently produced. In S12, a reference peak in the X-ray spectrum is identified using techniques such as peak searching, and necessity of the energy calibration is judged based on the reference peak. For example, the necessity of the energy calibration is judged based on whether or not the actually measured energy of the reference peak (actually measured energy) is within an energy range which is set based on an energy threshold which is prepared in advance. When it is judged that the energy calibration is necessary, a display to that effect is shown, and the energy calibration is automatically executed. The energy is corrected based on the deviation of the actually measured energy from the energy standard value; more specifically, such that the energy deviation is zero. Alternatively, the energy may be corrected based on a plurality of reference peaks.

In S14, necessity of the intensity calibration is judged based on the reference peak. For example, a determination intensity is set according to an intensity threshold with reference to an intensity standard value which is prepared in advance, and the necessity of the intensity calibration is judged based on whether or not the actually measured intensity of the reference peak (actually measured intensity) is smaller than the determination intensity. When it is judged that the intensity calibration is necessary, a display to that effect is shown, and the intensity calibration is automatically executed. The intensity of the X-ray generated by the X-ray generator may be corrected based on the deviation of the actually measured intensity from the intensity standard value; more specifically, such that the intensity deviation becomes zero. Alternatively, the intensity may be corrected based on a plurality of reference peaks.

Alternatively, in S12 and S14, in place of execution of the energy and intensity calibrations, control may be applied in which an error is displayed and the measurement is interrupted.

In S16, a spectrum after the calibration (or the spectrum for which it is judged that the calibration is not necessary) is analyzed. In S18, the analysis result is displayed. In the present embodiment, because the line-shaped member is provided as a permanent member, it is not necessary to place or exchange the calibration substance.

FIG. 5 shows an example of a setting screen of the energy threshold and the intensity threshold. A setting screen 80 includes a field 82 for setting the energy threshold and a field 84 for setting the intensity threshold. For example, an energy range for judging the necessity of the calibration is set as a range having a width corresponding to the energy threshold on both sides, centered at the energy standard value. Alternatively, for example, a determination intensity may be set at a position reduced from the reference of the intensity standard value by a ratio specified by the intensity threshold, and execution of the intensity calibration or an error may be determined when the actually measured intensity becomes lower than the determination intensity.

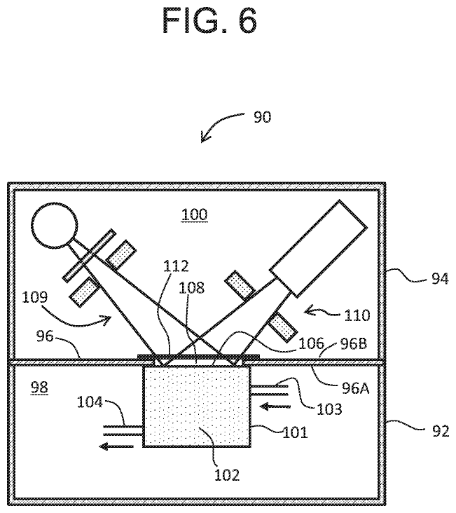

FIG. 6 shows a second configuration of the X-ray fluorescence analysis apparatus according to the present embodiment. An X-ray fluorescence analysis apparatus 90 comprises a lower part 92 and an upper part 94. An inside of the lower part 92 is a sample chamber 98 serving as the first space. An inside of the upper part 94 is a measurement chamber 100 serving as the second space. A horizontal plate 96 is provided between the sample chamber 98 and the measurement chamber 100. The horizontal plate 96 functions as the partitioning plate. The horizontal plate 96 has a lower surface 96A and an upper surface 96B.

A sample tank (sample cell) 101 is placed in the sample chamber 98, and a liquid sample 102 is housed in the sample tank 101. An injection path 103 and a discharge path 104 are connected to the sample tank 101. The sample is sent into the sample tank 101 through the injection path 103. The sample is discharged to the outside from the sample tank 101 through the discharge path 104. That is, a flow-type measurement is realized in which the sample is continuously measured while the sample is supplied. On an upper surface 106 of the sample tank 101, a film having X-ray transmissivity is provided as necessary. The upper surface 106 of the sample tank 101 or the film provided thereon is in contact with the lower surface 96A.

An X-ray irradiation unit 109 and an X-ray detection unit 110 are provided in the measurement chamber 100. An opening 108 for passing the X-ray is formed in the horizontal plate 96. A line-shaped member 112 for calibration is provided across the opening 108. More specifically, the line-shaped member 112 is a narrow line member having a straight line form, and is provided in a horizontal orientation along the horizontal plate. The line-shaped member 112 extends through a center of the opening 108, and a direction of the line-shaped member 112 is parallel to a direction of arrangement of the X-ray generator and the X-ray detector. The line-shaped member 112 is identical to the line-shaped member 44 shown in FIG. 1 or the like, and an operation and an advantage thereof are also identical to those of the line-shaped member 44.

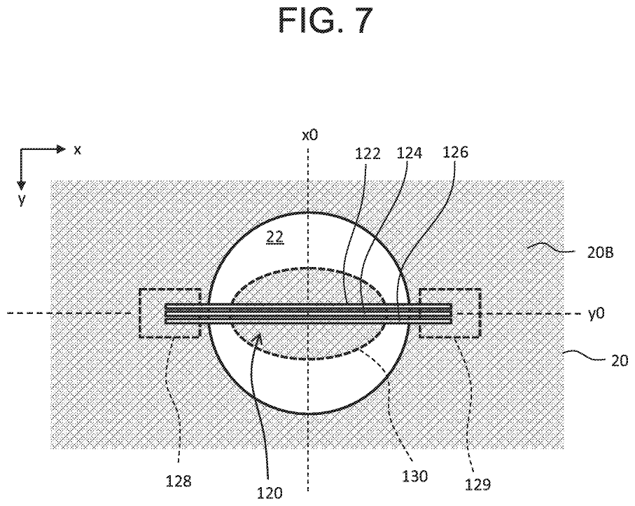

FIG. 7 shows an alternative configuration. In this alternative configuration, in place of a single line-shaped member, a line-shaped member array 120 is provided. Specifically, the line-shaped member array 120 is provided on the lower surface 20B of the horizontal plate 20. In the illustrated configuration, the line-shaped member array 120 includes three line-shaped members 122, 124, and 126. An end on one side of the line-shaped member array 120 is fixed on the horizontal plate 20 by a fixation member 128, and an end on the other side of the line-shaped member array 120 is fixed on the horizontal plate 20 by a fixation member 129. An X-ray passage area 130 appears in the opening 22.

The three line-shaped members 122, 124, and 126 are in a parallel relationship, and, of these members, the line-shaped member 124 at the center passes the center coordinates (x0, y0) of the opening 22 (that is, the center of the X-ray passage area 130) in the x direction. The line-shaped member 122 is provided adjacent to the line-shaped member 124 on one side, and the line-shaped member 126 is provided adjacent to the line-shaped member 124 on the other side.

The line-shaped members 122, 124, and 126 are formed from three substances different from each other. Each substance is a substance for calibration. In this manner, the energy calibration or the like may be executed by providing a plurality of line-shaped members and using three or more reference peaks caused thereby. When the alternatively configuration is employed also, an area of a portion of the line-shaped member array 120 over the opening 22 (that is, a portion over the X-ray passage area 130) is desirably set small.

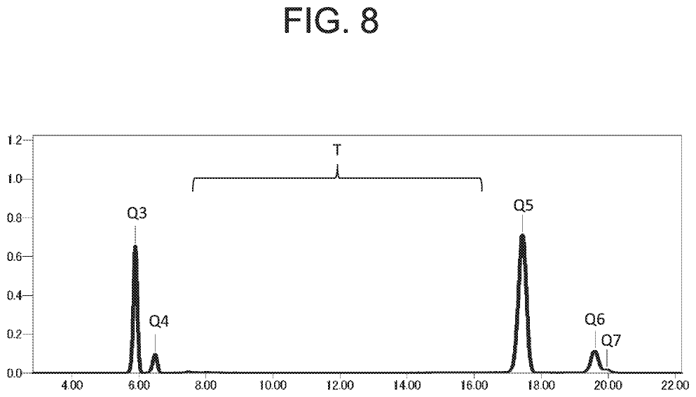

FIG. 8 shows a second example of an X-ray spectrum observed by the X-ray fluorescence analysis apparatus according to the present embodiment. In the illustrated example configuration, the X-ray spectrum includes a plurality of reference peaks Q3, Q4, Q5, Q6, and Q7 caused by the plurality of calibration substances. For example, the reference peaks Q3 and Q4 are caused by a first calibration substance, and the reference peaks Q5, Q6, and Q7 are caused by a second calibration substance. In the actual calibration, of these peaks, the reference peaks Q3 and Q5 are utilized. With calibration using a plurality of peaks, a more accurate calibration becomes possible. Desirably, the first calibration substance and the second calibration substance are selected such that the sample peak occurs in a section T between the reference peaks, or, in other words, such that the plurality of reference peaks are caused on both sides of the sample peak of interest.

According to the embodiment described above, because the X-ray fluorescence for calibration is observed by irradiation of the X-ray onto the sample, it becomes unnecessary to place the calibration member in place of the sample every time the calibration is executed.

1. An X-ray fluorescence analysis apparatus comprising:
a partitioning member that is provided between a first space which houses a sample and a second space adjacent to the first space, and on which an opening is formed;
an X-ray generator that is provided in the second space, and that generates an X-ray configured to be irradiated onto the sample through the opening;
a line-shaped member for calibration that is provided crossing the opening and along the partitioning member;
an X-ray detector that is provided in the second space, and that detects an X-ray fluorescence from the sample and an X-ray fluorescence from the line-shaped member; and
a spectrum producer that produces an X-ray fluorescence spectrum including a sample peak corresponding to the X-ray fluorescence from the sample and a reference peak corresponding to the X-ray fluorescence from the line-shaped member, based on a detection signal from the X-ray detector.

2. The X-ray fluorescence analysis apparatus according to claim 1, wherein
the line-shaped member crosses a central part of an X-ray passage area in the opening.

3. The X-ray fluorescence analysis apparatus according to claim 2, wherein
the X-ray generator irradiates the X-ray onto the sample from a first slanted direction,
the X-ray detector detects the X-ray fluorescence emitted from the sample in a second slanted direction and the X-ray fluorescence emitted from the line-shaped member in the second slanted direction, and
the line-shaped member is provided along a direction of arrangement of the X-ray generator and the X-ray detector.

4. The X-ray fluorescence analysis apparatus according to claim 1, wherein
the partitioning member has a first surface which faces the first space and a second surface which faces the second space, and
the line-shaped member is provided on the second surface.

5. The X-ray fluorescence analysis apparatus according to claim 4, wherein
respective ends of the line-shaped member are fixed on the second surface.

6. The X-ray fluorescence analysis apparatus according to claim 1, wherein
a plurality of line-shaped members are provided crossing the opening and along the partitioning member, and
the plurality of line-shaped members are formed from a plurality of calibration substances which differ from each other.

7. A method of calibrating an X-ray fluorescence analysis apparatus, comprising:
providing a line-shaped member for calibration crossing an opening formed on a partitioning member provided between a first space which houses a sample and a second space adjacent to the first space;
irradiating an X-ray generated in the second space toward the opening;
detecting an X-ray fluorescence from the line-shaped member in the second space;
producing an X-ray fluorescence spectrum including a reference peak corresponding to the X-ray fluorescence from the line-shaped member; and
executing at least one of energy calibration or intensity calibration based on at least one of an energy or an intensity of the reference peak.
